(19) United States
(12) Patent Application Publication
(10) Pub. No.: US 2004/0078291 A1
(43) Pub. Date: Apr. 22, 2004

(54) Method of electronic commerce transaction

(75) Inventors: Shinichiro Inoue, Kawasaki (JP); Hiroaki Kobayashi, Yokohama (JP); Mina Nishioka, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HITACHI, LTD., Tokyo (JP)

(21) Appl. No.: 10/646,215

(22) Filed: Aug. 22, 2003

(30) Foreign Application Priority Data
Oct. 17, 2002 (JP) 2002-302442

(51) Int. Cl. G06F 17/60

(52) U.S. Cl. 705/26

(57) ABSTRACT

The present invention is directed to systems and method of facilitating e-commerce transaction. In one embodiment, a method of facilitating e-commerce transaction comprises receiving a settlement request for a purchase account and related information sent from an end user system used by an end user to make a purchase from a seller or sent from a store system used by the seller. The related information includes a purchase price of the purchase and an identifier of the end user. The method includes determining whether the purchase account of the settlement request can be settled through financing, based on financing availability information which specifies a financing available amount of the end user, and the purchase price of the purchase. If it is determined that the purchase account can be settled, then a message that the purchase account can be settled through financing is outputted, and financing information regarding a charge account of the end user for the purchase is recorded, the charge account being determined based on the purchase price of the purchase.

### CROSS-REFERENCES TO RELATED APPLICATIONS

This application relates to and claims priority from Japanese Patent Application No. 2002-302442, filed on Oct. 17, 2002, the entire disclosure of which is incorporated herein by reference.

### BACKGROUND OF THE INVENTION

The present invention relates to technology for carrying out a transaction and settlement procedure via a network. In particular, the invention relates to e-commerce transaction via the Internet and other networks and its settlement procedure. Articles to trade on e-commerce according to the method of e-commerce transaction of the present invention may include services as well as goods.

There exists a previous method for carrying out settlement for an article purchased by an end user through an electronic store server, wherein a settlement accepting server determines whether the purchase account can be settled through the user's account appointed for transaction on the Internet, based on the account number and password sent from the purchaser (JP-A No. 2002-109419). According to the method set forth therein, if the settlement accepting server determines that the purchase account can be settled, it sends a notification of accepted settlement to the purchaser. Also, the settlement accepting server notifies the electronic store server that the settlement request from the purchaser has been accepted. By this notification, the seller can confirm that the article can be sold to the purchaser and, when it has been sold, its payment is transferred from the above user's account to the appointed seller's account. In JP-A No. 2002-109419, it is also mentioned that a monthly charge account of an end user can be settled once a month at a predetermined day of month.

According to the above reference, when one issues a purchase request for an article, the settlement accepting server accesses the computer system of the financial institution at which the purchaser has the account appointed for settlement. Through the access, the server obtains information about the limit of financing the end user that is the purchaser and determines whether the purchase account can be settled.

Financial institution computer systems which are called account systems may not operate continuously for 24 hours. Accordingly, the financial institution computer system may not be operating for a time period. The financial institution computer system may be unavailable in other situations, including natural disasters, loss of power, or other accidents or unforeseen circumstances. A problem of the above-mentioned previous method is that, for a purchase request issued from an end user when the financial institution computer system is not operating, it cannot be determined whether the purchase account can be settled.

### BRIEF SUMMARY OF THE INVENTION

The present invention is directed to systems and method of facilitating e-commerce transaction. In specific embodiments, the system essentially comprises an end user terminal which is used by a user who wishes to make a purchase via e-commerce, an affiliated store server which is managed by a web store for selling products or services, and central equipment. The end user terminal, the affiliated store server, and the central equipment are connected via a network. When the central equipment accepts a purchase request from the end user terminal, if predetermined conditions are satisfied, the central equipment executes a financing procedure for the purchase request. In some cases, the predetermined conditions include a condition that the purchase account of the article of purchase request is less than the preset financing available amount for the purchaser. The financing available amount information will typically be held by the settlement system and sent to the central equipment. When a purchase request is made, the central equipment detects whether the account system is now available and determines whether the purchase account can be settled through automatic financing when the account system is not available. When the account system is available, the account system executes the settlement procedure for the purchase account. In addition, the financing procedure may include adding the log of a new charge account for the purchase to the customer information sent from the account system and sending this information to the account system at predetermined intervals.

According to an aspect of the invention, a computer-implemented method of facilitating e-commerce transaction comprises receiving a settlement request for a purchase account and related information sent from an end user system used by an end user to make a purchase from a seller or sent from a store system used by the seller. The related information includes a purchase price of the purchase and an identifier of the end user. The method includes determining whether the purchase account of the settlement request can be settled through financing, based on financing availability information which specifies a financing available amount of the end user, and the purchase price of the purchase. If it is determined that the purchase account can be settled, then a message that the purchase account can be settled through financing is outputted, and financing information regarding a charge account of the end user for the purchase is recorded, the charge account being determined based on the purchase price of the purchase.

Another aspect of the invention is directed to a system for facilitating e-commerce transaction to which an end user system which is used by an end user to make a purchase from a seller and a store system used by the seller are connected via a network. The system comprises a receiver coupled with the network to receive a settlement request for a purchase account and related information sent from an end user system used by an end user to make a purchase from a seller or sent from a store system used by the seller, the related information including a purchase price of the purchase and an identifier of the end user; and a processor coupled with the receiver. A memory stores a program including a plurality of code modules which are executable by the processor. The plurality of code modules include a code module for determining whether the purchase account of the settlement request can be settled through financing, based on financing availability information which specifies financing available amount of the end user, and the purchase price of the purchase; a code module for outputting a message that the purchase account can be settled through financing upon determining that the purchase account can be settled; and a code module for recording financing information regarding a charge account of the end user for the purchase upon determining that the purchase account can be settled. The charge account is determined based on the purchase price of the purchase.

According to another aspect of this invention, in a computer readable medium storing a program for facilitating e-commerce transaction to which an end user system which is used by an end user to make a purchase from a seller and a store system used by the seller are connected via a network, the program comprises code for receiving a settlement request for a purchase account and related information sent from an end user system used by an end user to make a purchase from a seller or sent from a store system used by the seller. The related information includes a purchase price of the purchase and an identifier of the end user. The program further comprises code for determining whether the purchase account of the settlement request can be settled through financing, based on financing availability information which specifies financing available amount of the end user, and the purchase price of the purchase; code for outputting a message that the purchase account can be settled through financing upon determining that the purchase account can be settled; and code for recording financing information regarding a charge account of the end user for the purchase upon determining that the purchase account can be settled. The charge account is determined based on the purchase price of the purchase.

### BRIEF DESCRIPTION OF THE DRAWINGS

FIG. 1 is a system structural diagram for carrying out the method of e-commerce transaction in accordance with an exemplary embodiment of the invention.

FIG. 2 a flowchart (1 of 3) explaining an illustrative transaction process flow according to the method of the exemplary embodiment of the invention.

FIG. 3 a flowchart (2 of 3) explaining an illustrative transaction process flow according to the method of the exemplary embodiment of the invention.

FIG. 4 a flowchart (3 of 3) explaining an illustrative transaction process flow according to the method of the exemplary embodiment of the invention.

FIG. 5 shows an example of a table of transaction database (DB) of store 21.

FIG. 6 shows an example of a table of customer DB 31.

FIG. 7 shows an example of a table of bank list DB 32.

FIG. 8 shows an example of a table of financing DB 33.

FIG. 9 shows an example of a table of transaction DB 34.

FIG. 10 shows a login screen example.

FIG. 11 shows an example of an on/off status table 35.

FIG. 12 shows a screen example for confirming transaction specifics.

### DETAILED DESCRIPTION OF THE INVENTION

The present invention will be fully described hereinafter with reference to an exemplary embodiment thereof illustrated in the accompanying drawings.

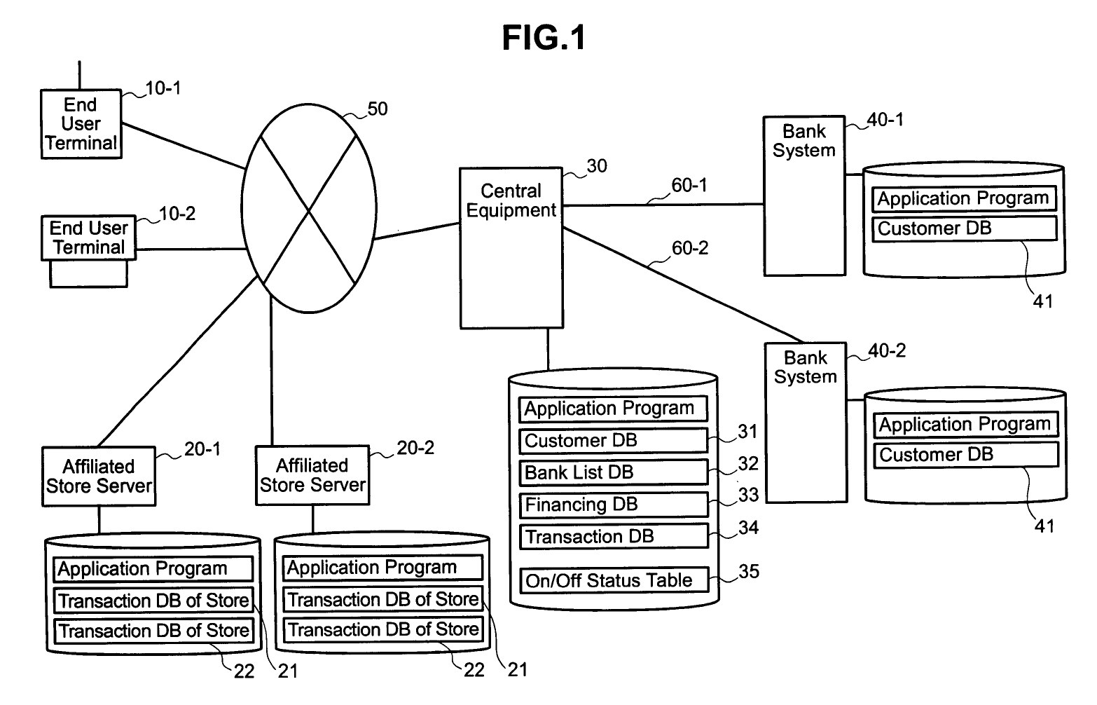

FIG. 1 shows a system structural diagram for carrying out the method of e-commerce transaction in accordance with the exemplary embodiment of the invention. The illustrative system depicted for explaining the invention is comprised of end user systems such as terminals 10-1, 10-2 which are used by end users who want to make a purchase of merchandise or service on e-commerce, affiliated store servers 20-1, 20-2 which are used by merchandise sellers (suppliers) to implement a shopping service on e-commerce, and central equipment 30 which performs e-commerce transactions including financing. The end user terminals 10-1, 10-2, affiliated store servers 20-1, 20-2, and the central equipment are networked via the Internet 50. The central equipment 30 is a data processing system, and may be any suitable computer system. Examples of the end user terminals 10 include mobile phones, personal computers, and Personal Digital Assistants (PDAs). For example, the end user terminal 10-1 may be a mobile phone and the end user terminal 10-2 a personal computer. Instead of the Internet 50, another network may be used for interconnecting the above terminals, servers and central equipment.

Moreover, the central equipment 30 is connected to systems of financial institutions, which are referred to as settlement systems or bank systems 40-1, 40-2, through leased lines 60-1, 60-2. In another embodiment, the central equipment 30 and the settlement systems 401, 40-2 may be connected to another network which in turn connects to the Internet 50 and the end user terminals 10.

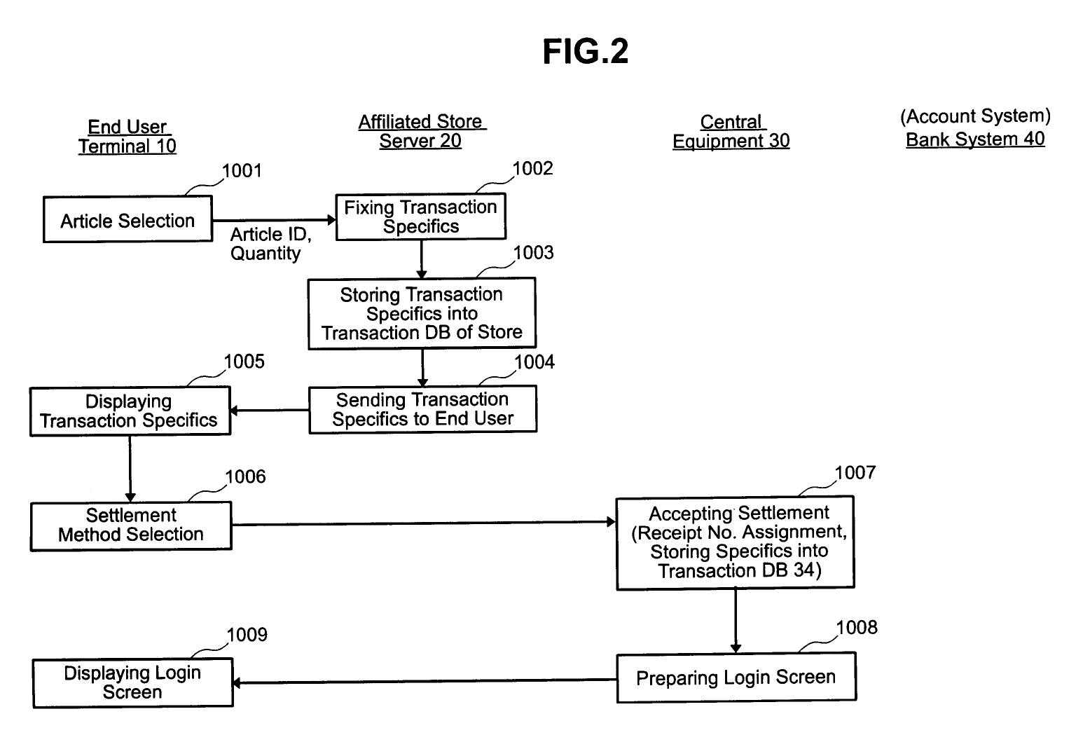

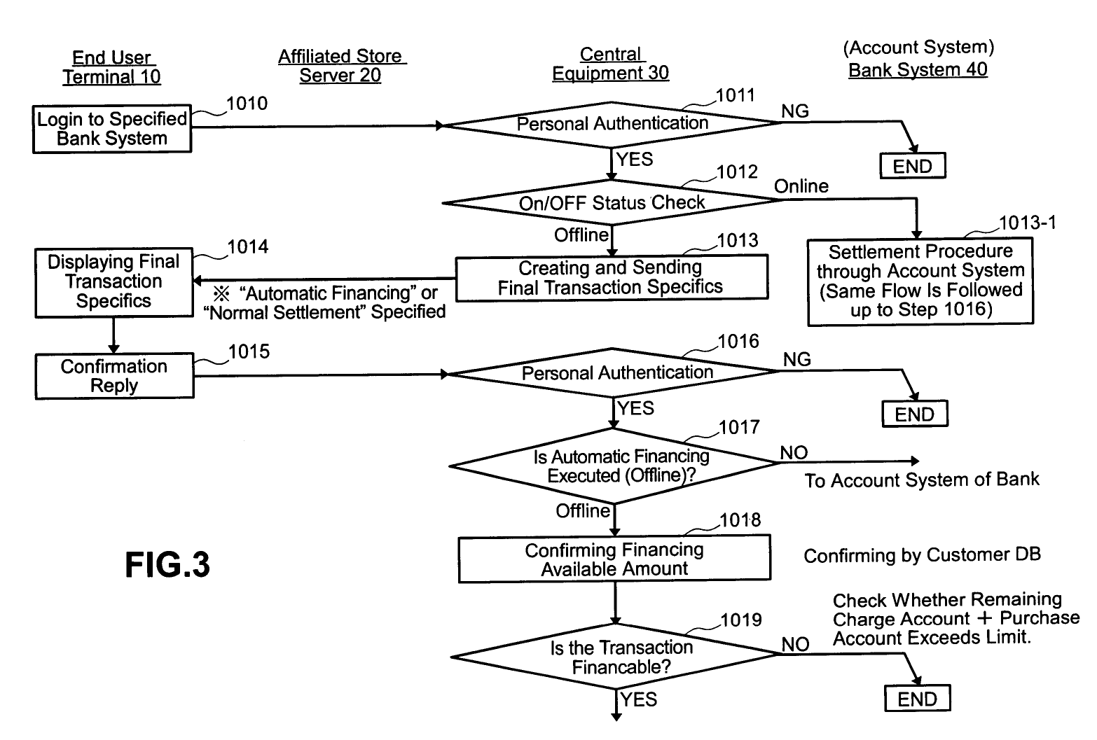

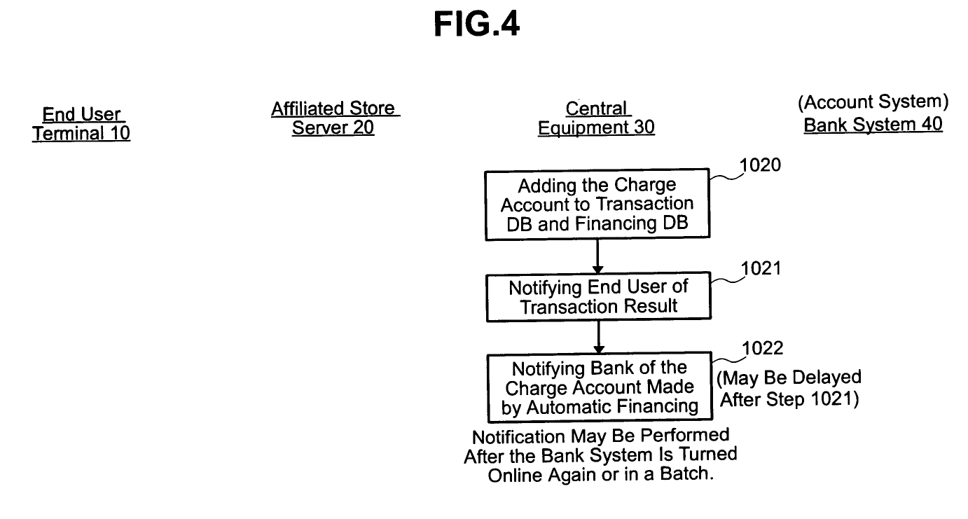

Next, with reference to the flowcharts shown in FIG. 2 through FIG. 4, an illustrative transaction process according to the method of e-commerce transaction of the present embodiment will be explained.

In step 1001, first, an end user terminal 10 executes an article selection procedure in response to the input by an end user who wants to make a purchase and sends the selected article and information to an affiliated store server 20. First, the end user selects an article to buy from a line of articles presented from the affiliated store server 20, using an input device such as a mouse. After the selection, the end user terminal 10 sends information including at least the identifier (ID) of the selected article and its quantity to the affiliated store server 20.

Next, in step 1002, the affiliated store server 20 fixes or sets the transaction specifics, according to the article ID and quantity. In the present embodiment, the above server fixes the article ID, quantity, the amount of money to pay, and the address of article delivery. First, the server calculates the amount of money to pay from the price of the article and its quantity. The affiliated store server 20 is provided with a database containing article attributes data including price per article and the server calculates the amount of money to pay for a transaction, using the database. The delivery address may be included in the information received from the end user terminal in step 1001. End user information including delivery address may be stored beforehand on the server, so that the server can retrieve the delivery address when receiving information identifying the end user (or end user terminal 10). If the article to buy is electronic content such as software programs and picture data, it may be delivered to the end user terminal 10 through the network and the terminal address should be specified.

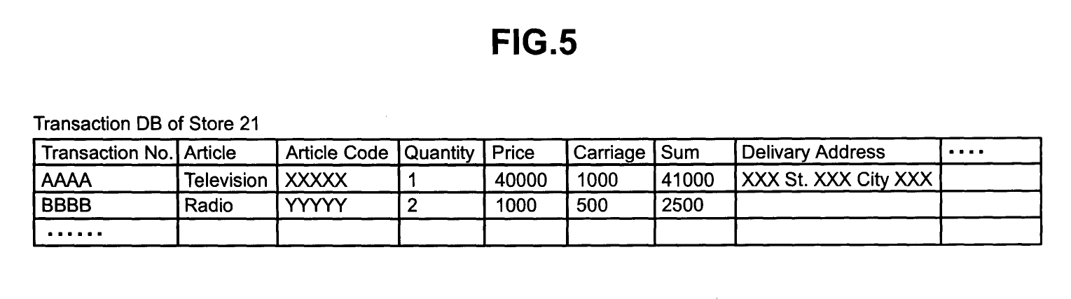

Next, in step 1003, the affiliated store server 20 stores the fixed transaction specifics into a transaction database (DB) of store 21. Exemplary specifics to be stored into the transaction DB of store 21 are illustrated in FIG. 5. Here, by way of example, transaction No. AAAA which identifies a transaction and its specifics are stored. This transaction shows that the end user is buying one television whose article code XXXXX is the article ID. The amount of money to pay including carriage (sum) is \41,000 and the delivery address is XXX St. XXX City XXX.

In step 1004, the affiliated store server 20 sends the transaction specifics to the end user terminal 10 and the end user terminal 10 displays the transaction specifics in step 1005. Then, the end user can check the transaction specifics. Here, the affiliated store server 20 may receive a confirmation reply or request to alter the specification from the end user terminal 10.

Next, in step 1006, the end user terminal 10 executes a settlement method selection procedure in response to the input by the end user. After the settlement method selection, the end user terminal 10 sends information including a bank ID identifying the bank that performs settlement and the amount of money to pay displayed in step 1005 to the central equipment 30. In the present embodiment, it is preferable that the above information further include an affiliated store ID identifying the affiliated store from which the end user is buying the article and the transaction No. fixed in step 1002. In the present embodiment, by way of example, the end user selects bank OOOO at which the end user's account appointed for settlement exists and its ID 9001 is sent to the central equipment. Moreover, the affiliated store ID 001, the transaction No. AAAA, and the sum \41,000, displayed in step 1005, are sent to the central equipment.

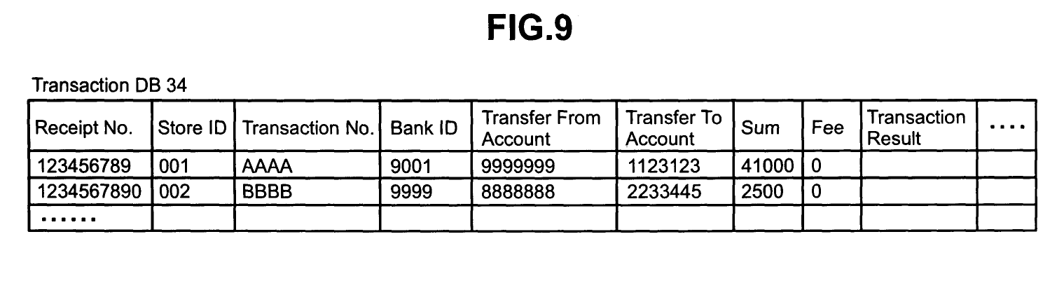

Next, in step 1007, the central equipment 30 executes a procedure of accepting the settlement method. The central equipment 30 first receives the information sent from the end user terminal in step 1006. The central equipment 30 assigns a receipt number that identifies the received information, that is, the settlement request (method) to that information. Then, the central equipment 30 stores the information with its receipt number, which has been sent from the end user terminal in step 1006, into a transaction DB 34. Exemplary specifics to be stored into the transaction DB 34 are illustrated in FIG. 9. In the present embodiment, by way of example, receipt No. 123456789 is assigned, and the affiliated store ID 001, transaction No. AAAA, bank ID 9001, and sum \41,000 are stored.

Moreover, in the transaction DB 34, the account number of the affiliated store ID is stored into the field of the transfer to account column. The transfer to account is fixed from a database storing the information about affiliated stores, which is not shown here.

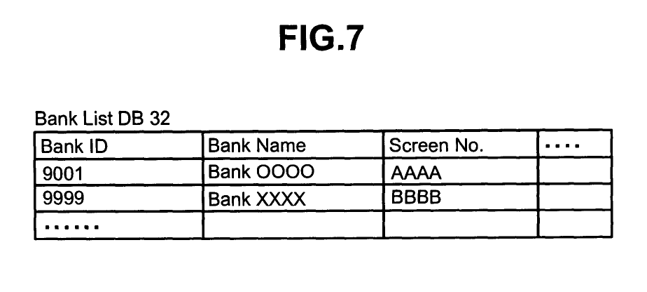

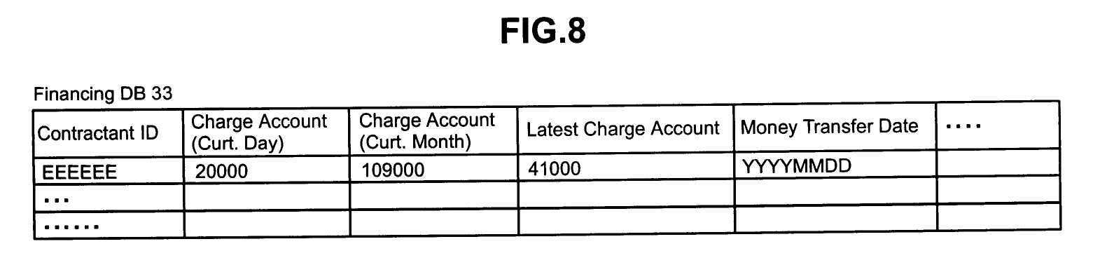

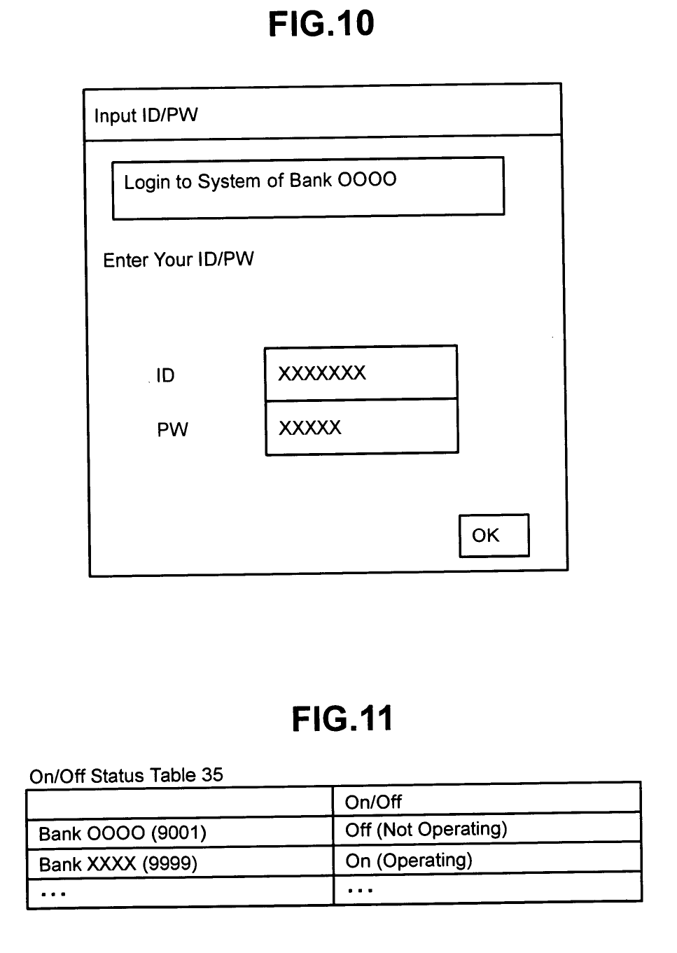

Next, in step 1008, the central equipment 30 prepares a login screen which prompts the user to log into the appointed bank system for a transfer procedure. The prepared login screen for user login to the system of bank OOOO for a transfer procedure is sent to the end user terminal 10. The login screen which is illustrated in FIG. 10 is displayed on the end user terminal 10 in step 1009. The login screen may be customized per bank. Together with the login screen, it may be preferable to send bank ID 9001 of bank OOOO and receipt No. 123456789 to the end user terminal. The login screen is prepared, based on its screen number stored on a bank list DB 32. Exemplary specifics stored on the bank list DB 32 are illustrated in FIG. 7. Here, the screen numbers are stored on the database, and the data of information to be presented on the screen may be stored.

In step 1010, the end user terminal 10 executes a procedure of login to bank OOOO in response to the user input. In the present embodiment, the end user terminal 10 sends his or her password (PW) and user ID (ID) entered by the end user to the central equipment. It may be preferable that the end user terminal send back the receipt No. 123456789 and bank ID 9001 as well.

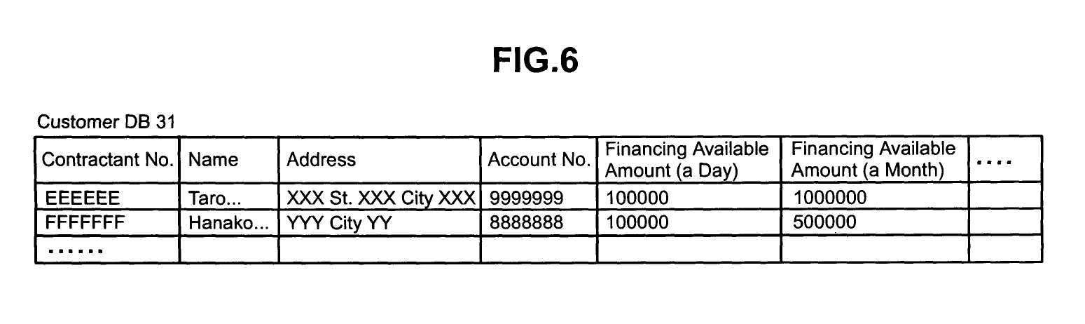

In step 1011, the central equipment 30 executes a personal authentication procedure, according to the password and user ID sent from the end user terminal 10. The central equipment searches a customer DB 31 for a contractant number that matches the user ID. Exemplary specifics stored on the customer DB 31 are illustrated in FIG. 6. In the present embodiment, the user ID “EEEEEE” has been sent from the end user terminal. Because the identical contractant No. “EEEEEE” is found, the central equipment compares the received password with that registered and held by to confirm whether both passwords match. As the result of the comparison, there is no contractant number matching the user ID or a password mismatch occurs, the central equipment sends an “unsuccessful authentication” error message to the end user terminal 10. In this case, the end user is allowed to reenter his or her password and user ID a predetermined number of times. If a password or user ID mismatch occurs by the predetermined number of times of retry, the transaction process terminates. If the authentication is successful, the process proceeds to step 1012.

In step 1012, the central equipment performs an on/off status check. This check determines whether the bank system 40 of bank OOOO is operating, according to an on/off status table 35. An example of entries of the on/off status table 35 is shown in FIG. 11. In this example, the bank system of bank OOOO is not operating, the process proceeds to step 1013. In fact, the central equipment starts an automatic financing procedure which includes step 1013 and subsequent steps.

If the bank system is operating, the process proceeds to step 1013-1 where the bank account system executes the settlement procedure. According to the normal procedure, the bank system 40 transfers the amount of money to pay from the end user's account to the affiliated store's account. Regardless of whether or not the bank is operating, in the present embodiment, the same process is executed up to step 1016 and, after that, the bank system executes the transfer procedure.

The on/off status table 35 should be updated so that the status of a bank system changes when receiving information specifying that the bank system is turned on or off. It may also be preferable to receive beforehand information specifying the daily operating duration of the bank system and store the on hours of the bank system into the table.

Next, in step 1013, the central equipment 30 creates and sends final transaction specifics to the end user terminal 10. Specifically, the central equipment sends information including the sum \41,000 and the end user's account number 9999999 identifying the end user's account for settlement. The information may include the receipt number 123456789, affiliated store ID 001 (or the name of the affiliated store), and the article to buy, television and its ID XXXXX.

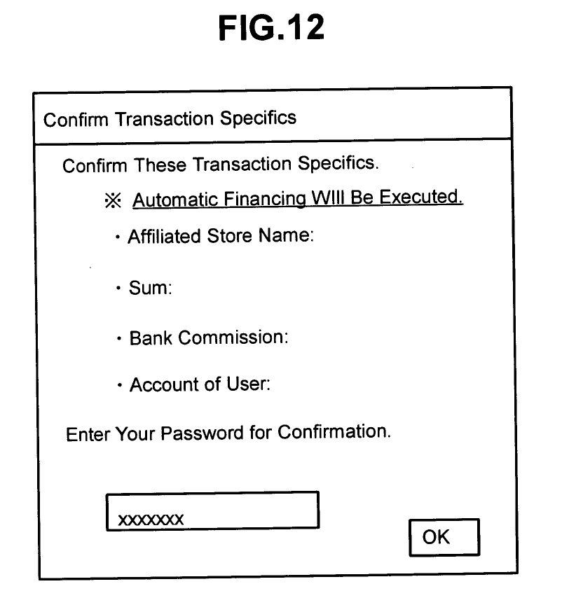

The information to be sent to the end user terminal 10 in step 1013 includes the specification of “automatic financing” or “transfer procedure” which will be executed, according to the result of the decision made at step 1012. In step 1014, the above information is displayed on the end user terminal 10, as will be illustrated in FIG. 12, where a message that “automatic financing” or “transfer procedure” will be executed appears distinguishably from other items. The “transfer procedure” may be referred to as “normal settlement.”

In step 1015, the end user terminal 10 sends a confirmation reply with the password for confirmation entered by the end user to the central equipment. The confirmation reply may include the receipt number and the contractant ID (EEEEEE) that identifies the end user in the automatic financing procedure. The contractant ID may be the contractant No. EEEEEE which should be sent to the end user terminal in the appropriate one of the foregoing steps or that assigned by the central equipment 30, based on the end user's account No. 9999999.

Next, in step 1016, the central equipment 30 executes the personal authentication procedure again. This procedure checks whether the password for confirmation sent from the end user terminal 10 is valid and carries out more strict personal authentication. Accordingly, this procedure and sending of the password for confirmation may not need to be performed.

If the end user is not authenticated as a user authorized to log into the system, the transaction process terminates as does in step 1011. If the end user is authenticated, the process proceeds to step 1017.

Next, in step 1017, it is determined whether “automatic financing” or “transfer procedure” is executed in the current transaction. This is determined, according to the result of the decision made at step 1012. Based on the receipt number, the transaction can be identified. The result of the decision made at step 1012, that is, “automatic financing” or “transfer procedure” which is executed, and the receipt number of the current transaction, for example, receipt No. 123456789 should be stored. When the same receipt number is sent from the end user terminal, the stored decision result “automatic financing” or “transfer procedure” is retrieved.

If the bank system 40 is not available due to some obstacle, the central equipment 30 may store “automatic financing” in the on/off status table 35. Examples of the obstacle include scheduled down time of the bank system, natural disasters, loss of power, data traffic volume problems between the central equipment 30 and the bank system 40, or other accidents or other unforeseen circumstances.

If the transfer procedure is executed, the above-described step 1013-1 is executed. If automatic financing is executed, that is, the bank system 40 is not operating, the process proceeds to step 1018.

If the bank system 40 is not available, it may be necessary for the central equipment administrator to obtain permission from the bank before performing “automatic financing.” In that case, the process may not proceed to step 1018 directly. Typically, the central equipment 30 is given pre-authorization in advance to proceed with “automatic financing” with the specified financing available amount, so that there is no need for the central equipment administrator to seek confirmation from the bank by telephone or other communication every time the bank system 40 is unavailable.

Next, in step 1018, the central equipment 30 checks the automatic financing available amount for the end user. The central equipment searches the customer DB 31 for the contractant No. EEEEEE sent from the end user terminal in step 1010 and checks the financing available amount for the contractant. In the present embodiment, it is retrieved from the database search that the financing available amount is \100000 a day and \1000000 a month. The financing available amount is the maximum amount a day or month that the bank can lend to the contractant, that is, the end user. The bank determines these amounts and the bank system 40 should send this information to its contractants, or end users periodically and the customer database should be updated accordingly. In addition to the above amounts a day and a month, the financing available amount for one lending may be limited.

Next, in step 1019, the central equipment 30 determines whether the current transaction is financeable. This is determined by a value which is positive or negative calculated by subtracting the purchase account of the current transaction plus the remaining charge account of the end user from the financing available amount of the end user confirmed in step 1018. For the contractant No. EEEEEE that is assumed to be the end user of the current transaction, the financing available amount is \100,000 a day and \1,000,000 a month and, based on which, the calculation is executed.

First, it is determined whether the current transaction is financeable by the financing available amount a day. From the financing DB 33, a “\20,000” value is retrieved as the charge account (the current day) of the contractant ID “EEEEEE.” By subtracting \20,000, the charge account (the current day) plus \41,000, the purchase account of the current transaction from \100,000, the financing available amount (a day), a value of +39,000 is obtained. Because this value is positive (+), it is determined that the current transaction is financeable. Then, a month basis calculation is executed. Here, if the above value is negative (−), it is determined that the current transaction is not financeable and the process terminates.

Then, it is determined whether the current transaction is financeable by the financing available amount a month. From the financing DB 33, a “\109,000” value is retrieved as the charge account (the current month) of the contractant ID “EEEEEE.” By subtracting \109,000, the charge account (the current month) plus \41,000, the purchase account of the current transaction from \1,000,000, the financing available amount (a month), a value of +850,000 is obtained. Because this value is positive (+), it is determined that the current transaction is financeable and the financing procedure is executed. If the above value is negative (−), it is determined that the current transaction is not financeable and the process terminates. The process proceeds to step 1020.

Next, the central equipment 30 adds the charge account of the current transaction to the transaction DB 34 and the financing DB 33. On the transaction DB 34, the transaction result is logged. In this case, it should be logged that automatic financing has been executed. On the financing DB 33, \41,000 is added to the values existing in the fields of charge account (the current day) and charge account (the current month) for the contractant that is the end user. Moreover, \41,000 is recorded in the field of latest charge account and the current date in the field of money transfer date.

In step 1021, the central equipment 30 notifies the end user terminal 10 of the transaction result, that is, automatic financing has been executed.

In step 1022, the central equipment 30 notifies the bank system relevant to the current transaction of the latest charge account of the end user that has been recorded in the field of latest charge account of the financing DB 33 in step 1020 and the ID “EEEEEE” of the end user (or account No. 9999999 of the end user). This notification may be sent to the bank system when the bank system is turned online again or in a batch at a predetermined time. This notification step may be executed immediately following the step 1021 or delayed.

When the bank system 40 is notified of the new charge account of the end user, it executes the transfer procedure and necessary operation, according to the notified charge account specifics.

In the e-commerce transaction process illustrated hereinbefore, the settlement of an article purchase account can be executed even when the bank system called the account system, relevant to the transaction, is not operating.

By using the method of e-commerce transaction in accordance with the present invention, it can be determined whether a purchase can be settled even during the off hours of the computer system of the financial institution that should execute the settlement procedure for the purchase and smooth e-commerce transactions can be performed.

The above-described arrangements of apparatus and methods are merely illustrative of applications of the principles of this invention and many other embodiments and modifications may be made without departing from the spirit and scope of the invention as defined in the claims. The scope of the invention should, therefore, be determined not with reference to the above description, but instead should be determined with reference to the appended claims along with their full scope of equivalents.

What is claimed is:

1. A computer-implemented method of facilitating e-commerce transaction, the method comprising:
receiving a settlement request for a purchase account and related information sent from an end user system used by an end user to make a purchase from a seller or sent from a store system used by the seller, the related information including a purchase price of the purchase and an identifier of the end user;
determining whether the purchase account of the settlement request can be settled through financing, based on financing availability information which specifies a financing available amount of the end user, and the purchase price of the purchase; and
if it is determined that the purchase account can be settled, then
outputting a message that the purchase account can be settled through financing; and
recording financing information regarding a charge account of the end user for the purchase, the charge account being determined based on the purchase price of the purchase.

2. A method as recited in claim 1, further comprising, for an account system of a financial institution at which the end user has an account that is appointed for settlement of the settlement request, detecting whether the account system is available, and wherein the step of determining whether the purchase account of the settlement request can be settled through financing is performed when the account system is not available.

3. A method as recited in claim 2, further comprising receiving the financing availability information of the end user from the account system at predetermined intervals and replacing the financing availability information stored in a data processing system by the received financing availability information.

4. A method as recited in claim 2, further comprising sending the recorded financing information to the account system of the end user at predetermined intervals.

5. A method as recited in claim 2, further comprising:
receiving a maximum allowable financing information which specifies a value up to which the end user is allowed to get financing as the financing availability information and a charge account information which specifies a remaining charge account of the end user from the account system of the end user; and
determining whether the purchase account can be settled through financing, based on the received maximum allowable financing information and charge account information.

6. A method as recited in claim 5, wherein it is determined that the purchase account can be settled through financing if a value obtained by subtracting the amount of money specified by the charge account information and the purchase price of the purchase from a value specified by the maximum allowable financing information is not less than 0.

7. A method as recited in claim 5, wherein the maximum allowable financing information and the charge account information are received from the account system at predetermined intervals.

8. A system for facilitating e-commerce transaction to which an end user system which is used by an end user to make a purchase from a seller and a store system used by the seller are connected via a network, the system comprising:
a receiver coupled with the network to receive a settlement request for a purchase account and related information sent from an end user system used by an end user to make a purchase from a seller or sent from a store system used by the seller, the related information including a purchase price of the purchase and an identifier of the end user;
a processor coupled with the receiver; and
a memory storing a program including a plurality of code modules which are executable by the processor, the plurality of code modules including,
a code module for determining whether the purchase account of the settlement request can be settled through financing, based on financing availability information which specifies financing available amount of the end user, and the purchase price of the purchase;
a code module for outputting a message that the purchase account can be settled through financing upon determining that the purchase account can be settled; and
a code module for recording financing information regarding a charge account of the end user for the purchase upon determining that the purchase account can be settled, the charge account being determined based on the purchase price of the purchase.

9. A system as recited in claim 8, further comprising a connecting module configured to connect to an account system of a financial instruction at which the end user has an account that is appointed for settlement of the settlement request; a detecting module configured to detect whether the account system is available, and wherein the determining module is configured to determine whether the purchase account of the settlement request can be settled through financing when the account system is not available.

10. A system as recited in claim 9, wherein the connecting module is configured to receive the financial availability information from the account system at predetermined intervals, and wherein the program is executable by the processor to record the received financial availability information.

11. A system as recited in claim 9, further comprising a sending module configured to send the recorded financing information to the account system at predetermined intervals.

12. A system as recited in claim 11, wherein the connecting module is configured to receive the maximum allowable financing information and the charge account information from the account system at predetermined intervals.

13. A system as recited in claim 9, wherein the connecting module is configured to receive the maximum allowable financing information which specifies a value up to which the end user is allowed to get financing as the financing availability information and a charge account information which specifies the remaining charge account of the end user from the account system; and wherein the program is executable by the processor to determine whether the purchase account can be settled through financing, based on the received maximum allowable financing information and charge account information.

14. A system as recited in claim 13, wherein the program is executable by the processor to determine that the purchase account can be settled through financing if a value obtained by subtracting the amount of money specified by the charge account information and the cost required to buy the article from a value specified by the maximum allowable financing information is not less than 0.

15. A system for facilitating e-commerce transaction to which an end user system which is used by an end user to make a purchase from a seller and a store system used by the seller are connected via a network, the system comprising:
means for receiving a settlement request for a purchase account and related information sent from an end user system used by an end user to make a purchase from a seller or sent from a store system used by the seller, the related information including a purchase price of the purchase and an identifier of the end user;
means for determining whether the purchase account of the settlement request can be settled through financing, based on financing availability information which specifies financing available amount of the end user, and the purchase price of the purchase;
means for outputting a message that the purchase account can be settled through financing upon determining that the purchase account can be settled; and
means for recording financing information regarding a charge account of the end user for the purchase upon determining that the purchase account can be settled, the charge account being determined based on the purchase price of the purchase.

16. A system as recited in claim 15 further comprising:
means for connecting to an account system of an account system of a financial institution at which the end user has an account that is appointed for settlement via a second network; and
means for detecting whether the account system is available via the second network,
wherein the determining means determines whether the purchase account can be settled through financing when the account system is not available.

17. A system as recited in claim 16 wherein the connecting means receives the financing availability information from the account system at predetermined intervals, and wherein the recording means records the received financing availability information.

18. A system as recited in claim 16 further comprising means for sending the recorded financing information to the account system at predetermined intervals.

19. In a computer readable medium storing a program for facilitating e-commerce transaction to which an end user system which is used by an end user to make a purchase from a seller and a store system used by the seller are connected via a network, the program comprising:
code for receiving a settlement request for a purchase account and related information sent from an end user system used by an end user to make a purchase from a seller or sent from a store system used by the seller, the related information including a purchase price of the purchase and an identifier of the end user;
code for determining whether the purchase account of the settlement request can be settled through financing, based on financing availability information which specifies financing available amount of the end user, and the purchase price of the purchase;
code for outputting a message that the purchase account can be settled through financing upon determining that the purchase account can be settled; and
code for recording financing information regarding a charge account of the end user for the purchase upon determining that the purchase account can be settled, the charge account being determined based on the purchase price of the purchase.

20. A program as recited in claim 19, further comprising:
code for connecting to an account system of an account system of a financial institution at which the end user has an account that is appointed for settlement via a second network; and
code for detecting whether the account system is available via the second network,
wherein the code for determining determines whether the purchase account can be settled through financing when the account system is not available.

21. A program as recited in claim 20 further comprising code for sending the recorded financing information to the account system at predetermined intervals.
